(19) United States
(12) Patent Application Publication
(10) Pub. No.: US 2024/0149899 A1
(43) Pub. Date: May 9, 2024

(54) RISK OF OCCURRENCE CALCULATING APPARATUS, RISK OF OCCURRENCE DISPLAYING SYSTEM, AND RISK OF OCCURRENCE CALCULATING METHOD

(71) Applicant: NEC Corporation, Minato-ku, Tokyo (JP)

(72) Inventor: Chisato Sugawara, Tokyo (JP)

(73) Assignee: NEC Corporation, Minato-ku, Tokyo (JP)

(21) Appl. No.: 18/280,323

(22) PCT Filed: Mar. 9, 2021
(86) PCT No.: PCT/JP2021/009261

§ 371 Date: Sep. 5, 2023

(51) Int. Cl. B60W 50/14; B60W 40/02; G06T 7/70; G06V 20/56

(52) U.S. Cl. CPC B60W 50/14; B60W 40/02; G06T 7/70; G06V 20/588; B60W 2050/146; B60W 2420/403; B60W 2552/35; B60W 2555/20; B60W 2556/40; G06T 2207/30252

(57) ABSTRACT

A risk of occurrence calculating apparatus includes an image analyzing unit configured to analyze an image of a road; an environmental information acquiring unit configured to acquire environmental information of the surroundings of the road; a risk of occurrence calculating unit configured to calculate a risk of occurrence indicating the likelihood that an obstructing factor that may hinder passage on the road occurs, based on an analysis result resulting from an analysis by the image analyzing unit and the environmental information acquired by the environmental information acquiring unit; and a display controlling unit configured to link the risk of occurrence to map information indicating position information of the road.

### TECHNICAL FIELD

The present invention relates to risk of occurrence calculating apparatuses, risk of occurrence displaying systems, risk of occurrence calculating methods, and risk of occurrence calculating programs.

### BACKGROUND ART

Patent Literature 1 describes a server that detects damage to a road based on environmental information, such as temperature, pressure, humidity, rainfall, snowfall, wind direction, wind pressure, or a road surface image, and assigns a route accordingly.

Patent Literature 2 describes a navigation apparatus that provides a driver with a rendition of an output detection result of road surface information and thus provides an optimal route choice avoiding frozen or snow-covered roads.

Patent Literature 3 indicates that cameras that separately capture an ultraviolet photograph, an infrared photograph, and a temperature distribution photograph are prepared and feature values of a road surface condition are calculated.

Patent Literature 4 describes a use of an all-sky fisheye camera and a temperature sensor to calculate how likely a road surface is to become frozen.

Patent Literature 5 indicates that a dampness and snow accumulation image corresponding to a road surface condition to be detected is captured in advance with that image linked to a weather condition, such as clear sky, cloud, or nighttime, serving as a possible factor of external disturbance, and such reference images are accumulated and compared to a newly captured inspection image to determine a road surface condition.

Non Patent Literature 1 describes displaying of information of currently frozen roads.

Non Patent Literature 2 describes conditions in which a pothole is formed.

### CITATION LIST

### Patent Literature

Patent Literature 1: International Patent Publication No. WO2017/111126
Patent Literature 2: Japanese Unexamined Patent Application Publication No. H11-051682
Patent Literature 3: Japanese Patent No. 4814855
Patent Literature 4: Japanese Unexamined Patent Application Publication No. 2009-042115
Patent Literature 5: Japanese Unexamined Patent Application Publication No. 2003-240869

### Non Patent Literature

Non Patent Literature 1: The Ministry of Land, Infrastructure, Transport and Tourism, “Winter Road Information,” [online], [accessed on Feb. 15, 2021], Internet, <https://www.mlit.go.jp/road/fuyumichi/fuyumichi.html>.
Non Patent Literature 2: Kimio Maruyama, Ryuuji Abe, and Takashi Kimura, “The conditions of damage to pavements that occurs during snow-melting season and the mechanism of the damage,” [online], [accessed on Feb. 15, 2021], Internet, <https://www.mlit.go.jp/chosahokoku/giken/program/kadai/pdf/jusyo/H26/anzen2_02.pdf>.

### SUMMARY OF INVENTION

### Technical Problem

For example, a fixed camera that detects freezing of a road merely presents information regarding freezing at one location, such as on a mountain trail or near a bridge. Information outside the range that can be captured by a fixed camera remains unknown until one goes out to that location. Therefore, detecting, for example, freezing in a range that is not captured by such a fixed camera requires a dedicated camera, a dedicated sensor, a dedicated vehicle, and so forth, which incurs a cost.

Furthermore, a hole formed in a road (referred to below as a pothole), for example, becomes a danger to passing vehicles, and thus such a pothole needs to be repaired by a local government managing the road. In reality, however, locating an existing pothole is difficult unless a resident calls in with a complaint, and potholes are subject to breakdown maintenance-type management. Under proper circumstances, preventive maintenance-type management is desirable in which an occurrence of a pothole is predicted before it is formed and the pavement is repaired before the road deteriorates due to a pothole. This thinking is in line with the fact that the Ministry of Land, Infrastructure, Transport and Tourism is calling, in its road management guideline, for a shift to preventive maintenance.

As in the examples described above, various services are expected in regard to road management.

The present disclose has been made to address such an issue and is directed to providing a risk of occurrence calculating apparatus, a risk of occurrence displaying system, a risk of occurrence calculating method, and a risk of occurrence calculating program that each can improve a service necessary for road management.

### Solution to Problem

A risk of occurrence calculating apparatus according to the present disclosure includes: image analyzing means configured to analyze an image of a road; environmental information acquiring means configured to acquire environmental information of surroundings of the road; risk of occurrence calculating means configured to calculate a risk of occurrence indicating a likelihood that an obstructing factor that may hinder passage on the road occurs, based on an analysis result resulting from an analysis by the image analyzing means and the environmental information acquired by the environmental information acquiring means; and display controlling means configured to link the risk of occurrence to map information indicating position information of the road.

A risk of occurrence displaying system according to the present disclosure includes: a mobile imaging apparatus configured to capture an image of a road while moving and acquire position information of the road; a risk of occurrence calculating apparatus configured to calculate a risk of occurrence indicating a likelihood that an obstructing factor that may hinder passage on the road occurs, based on an analysis result resulting from an analysis of the image output from the mobile imaging apparatus and environmental information of surroundings of the road, and link the calculated risk of occurrence to map information indicating the position information of the road; and a display apparatus configured to display the map information to which the risk of occurrence has been linked by the risk of occurrence calculating apparatus.

A risk of occurrence calculating method according to the present disclosure includes: analyzing an image of a road; acquiring environmental information of surroundings of the road; calculating a risk of occurrence indicating a likelihood that an obstructing factor that may hinder passage on the road occurs, based on an analysis result resulting from an analysis of the image and the acquired environmental information; and linking the risk of occurrence to map information indicating position information of the road.

A risk of occurrence calculating program according to the present disclosure causes a computer to execute: analyzing an image of a road; acquiring environmental information of surroundings of the road; calculating a risk of occurrence indicating a likelihood that an obstructing factor that may hinder passage on the road occurs, based on an analysis result resulting from an analysis of the image and the acquired environmental information; and linking the risk of occurrence to map information indicating position information of the road.

### Advantageous Effects of Invention

The present disclose can provide a risk of occurrence calculating apparatus, a risk of occurrence displaying system, a risk of occurrence calculating method, and a risk of occurrence calculating program that each can improve a service necessary for road management.

### BRIEF DESCRIPTION OF DRAWINGS

FIG. 1 is a configuration diagram showing an example of a risk of occurrence displaying system according to an outline of an example embodiment.

FIG. 2 is a block diagram showing an example of a risk of occurrence calculating apparatus according to an outline of an example embodiment.

FIG. 3 is a flowchart showing an example of a risk of occurrence calculating method according to an outline of an example embodiment.

FIG. 4 is a configuration diagram showing an example of a risk of occurrence displaying system according to a first example embodiment.

FIG. 5 is a block diagram showing an example of a mobile imaging apparatus according to the first example embodiment.

FIG. 6 is a sequence diagram showing an example of a risk of occurrence displaying method according to the first example embodiment.

FIG. 7 is a flowchart showing an example of a mobile imaging method according to the first example embodiment.

FIG. 8 is a flowchart showing an example of a risk of occurrence calculating method according to the first example embodiment.

FIG. 9 is a flowchart showing an example of a method of calculating a risk of occurrence of road surface freezing according to the first example embodiment.

FIG. 10 is a flowchart showing an example of a method of calculating a risk of occurrence of a pothole according to the first example embodiment.

### EXAMPLE EMBODIMENT

Hereinafter, some example embodiments will be described with reference to the drawings. In the following description and drawings, omissions and simplifications are made, as appropriate, to make the description clearer. In the drawings, identical elements are given identical reference characters, and their repetitive description is omitted, as necessary.

### Outline of Example Embodiment

An outline of an example embodiment will be described. A risk of occurrence displaying system according to an example embodiment estimates, as a risk of occurrence, the likelihood that an obstructing factor that obstructs passage on a road occurs in the future and displays the estimated risk of occurrence on a map.

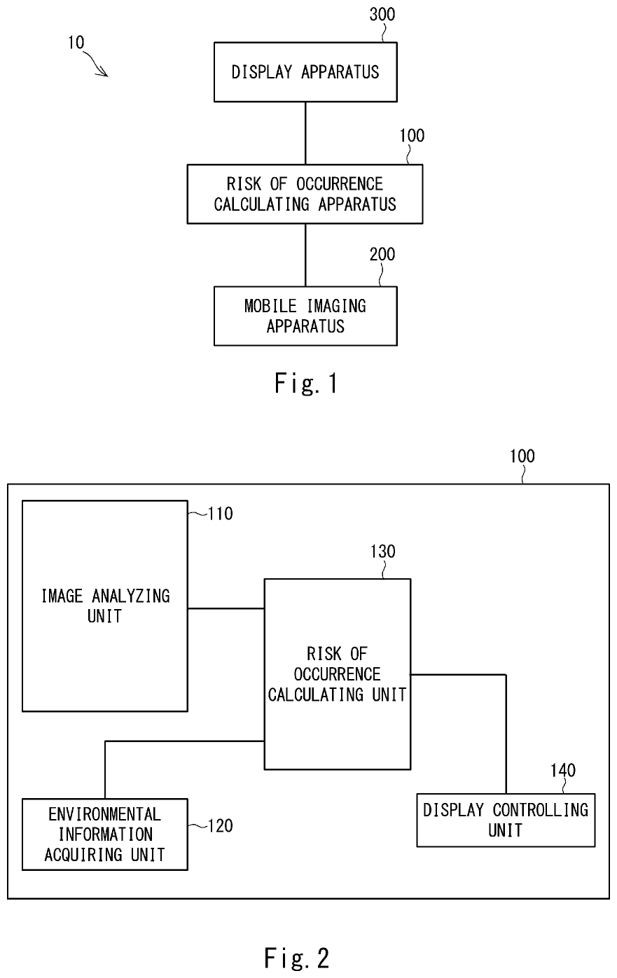

FIG. 1 is a configuration diagram showing an example of a risk of occurrence displaying system according to an outline of an example embodiment. As shown in FIG. 1, a risk of occurrence displaying system 10 includes a risk of occurrence calculating apparatus 100, a mobile imaging apparatus 200, and a display apparatus 300. The risk of occurrence calculating apparatus 100, the mobile imaging apparatus 200, and the display apparatus 300 have functions as, respectively, a risk of occurrence calculating means that calculates a risk of occurrence, a mobile imaging means that captures an image while moving, and a display means.

The mobile imaging apparatus 200 captures an image of a road while moving and also acquires position information of the road. Based on an analysis result resulting from an analysis of the image of the road output from the mobile imaging apparatus 200 and environmental information of the surroundings of the road, the risk of occurrence calculating apparatus 100 calculates a risk of occurrence indicating the likelihood that an obstructing factor that obstructs passage on the road occurs. The risk of occurrence calculating apparatus 100 then links the calculated risk of occurrence to map information indicating the position information of the road. The display apparatus 300 displays the map information to which the risk of occurrence has been linked by the risk of occurrence calculating apparatus 100.

FIG. 2 is a block diagram showing an example of a risk of occurrence calculating apparatus 100 according to an outline of an example embodiment. As shown in FIG. 2, the risk of occurrence calculating apparatus 100 includes an image analyzing unit 110, an environmental information acquiring unit 120, a risk of occurrence calculating unit 130, and a display controlling unit 140. The image analyzing unit 110, the environmental information acquiring unit 120, the risk of occurrence calculating unit 130, and the display controlling unit 140 have functions as, respectively, an image analyzing means, an environmental information acquiring means, a risk of occurrence calculating means, and a display controlling means.

The image analyzing unit 110 analyzes an image of a road. The environmental information acquiring unit 120 acquires environmental information of the surroundings of the road. Based on an analysis result resulting from an analysis by the image analyzing unit 110 and the environmental information acquired by the environmental information acquiring unit 120, the risk of occurrence calculating unit 130 calculates a risk of occurrence indicating the likelihood that an obstructing factor that obstructs passage on the road occurs. The display controlling unit 140 links the risk of occurrence to map information indicating position information of the road.

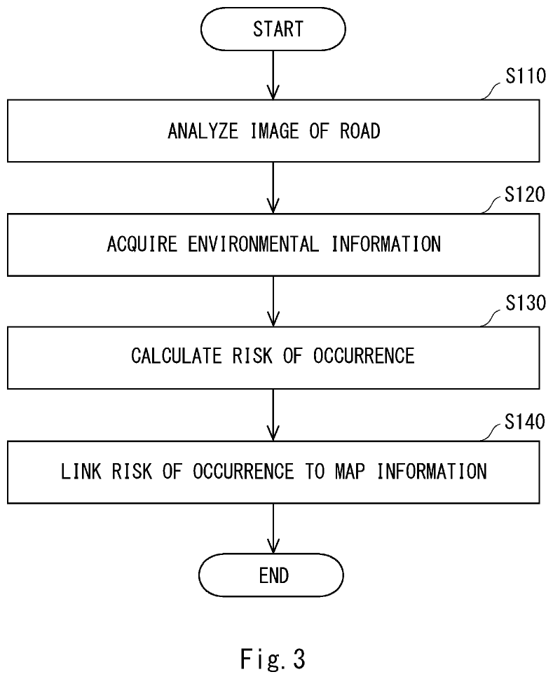

FIG. 3 is a flowchart showing an example of a risk of occurrence calculating method according to an outline of an example embodiment. As indicated at step S110 in FIG. 3, an image of a road is analyzed. As indicated at step S120, environmental information of the surroundings of the road is acquired. It is to be noted that the order of steps S110 and S120 is not limited to the above, and the order may be reversed, or steps S110 and S120 may be performed simultaneously.

Next, as indicated at step S130, based on an analysis result resulting from an analysis of the image and the acquired environmental information, a risk of occurrence indicating the likelihood that an obstructing factor that obstructs passage on the road occurs is calculated. Next, as indicated at step S140, the risk of occurrence is linked to map information indicating position information of the road.

A risk of occurrence calculating program programming the risk of occurrence calculating method according to the present example embodiment may be executed by a computer.

The risk of occurrence displaying system 10 according to the present example embodiment can estimate and present a risk of occurrence indicating the likelihood that an obstructing factor that obstructs passage on a road occurs in the future. This makes it possible to improve a service pertaining to road management.

### First Example Embodiment

Next, a risk of occurrence displaying system according to a first example embodiment will be described. The risk of occurrence displaying system according to the present example embodiment, by integrally taking into account conditions in which road surface freezing or a pothole is likely to occur, for example, estimates the likelihood that road surface freezing or a pothole occurs in the future as a risk of occurrence and displays the risk of occurrence on a map.

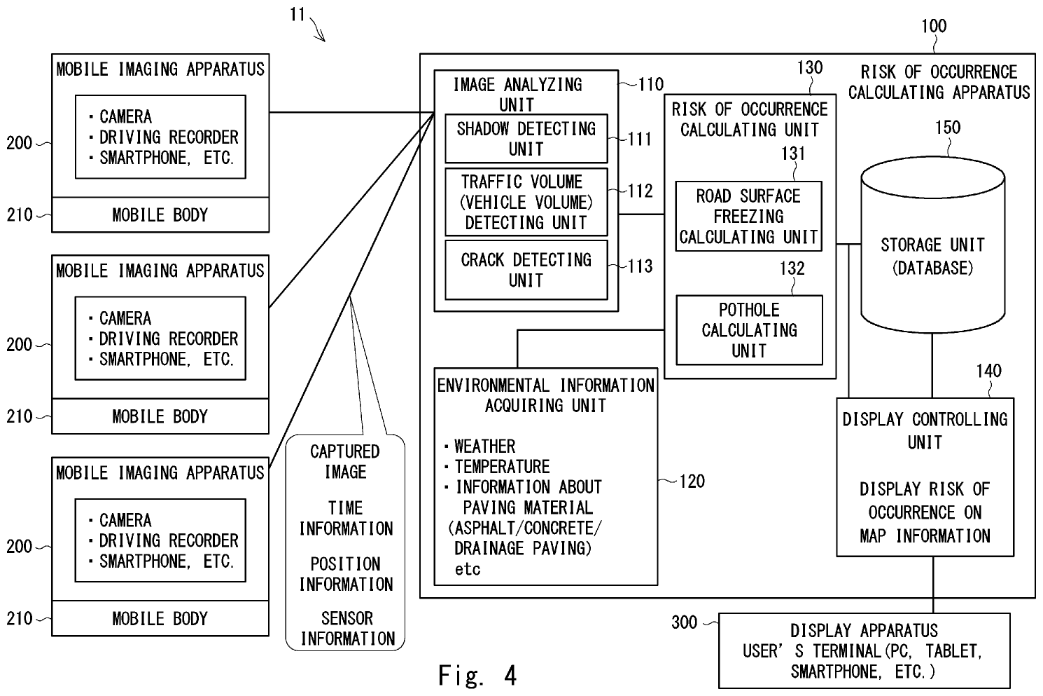

FIG. 4 is a configuration diagram showing an example of a risk of occurrence displaying system according to the first example embodiment. As shown in FIG. 4, a risk of occurrence displaying system 11 according to the present example embodiment includes a risk of occurrence calculating apparatus 100, a mobile imaging apparatus 200, and a display apparatus 300. The risk of occurrence displaying system 11 may include one mobile imaging apparatus 200 or a plurality of mobile imaging apparatuses 200. Likewise, the risk of occurrence displaying system 11 may include one display apparatus 300 or a plurality of display apparatuses 300. Hereinafter, <Mobile Imaging Apparatus>, <Risk of Occurrence Calculating Apparatus>, and <Display Apparatus> will be described, and thereafter <Risk of Occurrence Displaying Method>, <Mobile Imaging Method>, and <Risk of Occurrence Calculating Method> will be described.

### <Mobile Imaging Apparatus>

A mobile imaging apparatus 200 has an imaging function, such as a camera, and captures an image of a road while moving. Thus, the mobile imaging apparatus 200 is used while placed on a mobile body 210. The mobile body 210 may be, for example, a vehicle, a drone, or a person. The mobile imaging apparatus 200 may use, as a camera, a driving recorder provided in a vehicle, a smartphone carried by an occupant of a vehicle, a camera attached to a drone, or a camera carried by a person walking. Furthermore, the mobile imaging apparatus 200 may use an omnidirectional camera as a camera, and there is no limitation on the type of a camera or on the number of cameras. In this manner, the mobile imaging apparatus 200 captures an image of a road while moving with use of the mobile body 210 and while operating an imaging function, such as a camera.

Aside from a typical vehicle like an automobile, a patrolling vehicle of a local government, a delivery vehicle, or a garbage truck, for example, may be used as the mobile body 210. In such a case, a patrolling vehicle, a delivery vehicle, or a garbage truck travels within a city as usual and collects an image including information about a paved surface. Instead of using a typical vehicle, for example, the mobile imaging apparatus 200 may use, as the mobile body 210, a mobile body 210 manufactured to be dedicated to the risk of occurrence displaying system 11.

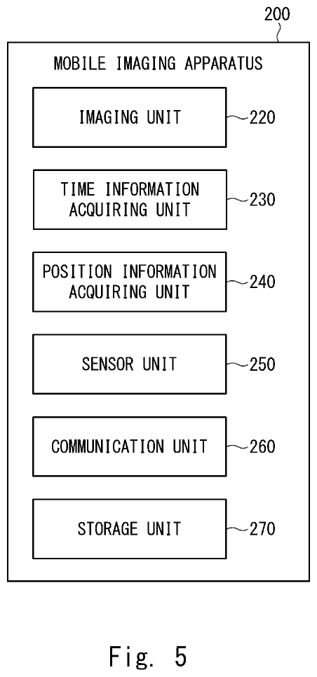

FIG. 5 is a block diagram showing an example of a mobile imaging apparatus 200 according to the first example embodiment. As shown in FIG. 5, the mobile imaging apparatus 200 includes an imaging unit 220, a time information acquiring unit 230, a position information acquiring unit 240, a sensor unit 250, a communication unit 260, and a storage unit 270. The imaging unit 220, the time information acquiring unit 230, the position information acquiring unit 240, the sensor unit 250, the communication unit 260, and the storage unit 270 have functions as, respectively, an imaging means, a time information acquiring means, a position information acquiring means, a sensor means, a communication means, and a storage means.

The imaging unit 220 is, for example, a camera. The imaging unit 220 may be served by a camera of a driving recorder or by a camera of a smartphone. The imaging unit 220 may capture an image in the direction in which the mobile body 210 moves, in the crosswise direction of the mobile body 210, or in all directions. The imaging unit 220 may capture images of one or more spots simultaneously. An image that the imaging unit 220 captures may be a still image or a moving image.

The imaging unit 220 captures an image of a road. The imaging unit 220 may capture an image of shadow on a road or of a rut in a road. The imaging unit 220 may capture an image of a vehicle passing on a road or an image of snow that has accumulated on a road. The imaging unit 220 may capture an image of a road surface sign on a road or an image of a shoulder or a pedestrian walkway of a road. The imaging unit 220 may capture not only an image of a road but also an image of a region surrounding a road. For example, in an area of heavy snowfall, the imaging unit 220 may capture an image showing the height of snow that has accumulated on a roof, a utility pole, and/or a power line or an image showing the growth of an icicle.

The time information acquiring unit 230 acquires time information. The time information acquiring unit 230 is, for example, a clock. The time information acquiring unit 230 may acquire time information from a clock built in the mobile imaging apparatus 200 or from, for example, the internet via the communication unit 260. The time information acquiring unit 230 outputs acquired time information to the imaging unit 220. The imaging unit 220 links time information to a captured image.

The position information acquiring unit 240 acquires position information of the mobile imaging apparatus 200 and the mobile body 210. The position information acquiring unit 240 is, for example, a global positioning system (GPS) receiver. The position information acquiring unit 240 outputs acquired position information to the imaging unit 220. The imaging unit 220 links position information to a captured image.

The sensor unit 250 is, for example, an acceleration sensor. The sensor unit 250 is a sensor that detects a change in the acceleration observed when the mobile body 210 travels. The sensor unit 250 further detects how the traveling mobile body 210 vibrates due to a crack or a rut in a road surface. This makes it possible to estimate the international roughness index (IRI) of a road surface. The sensor unit 250 may include a sensor that detects meteorological data, such as temperature, snowfall, or wind speed.

The communication unit 260 transmits a captured image to which time information and position information have been linked to the risk of occurrence calculating apparatus 100. The communication unit 260 transmits, aside from a captured image, time information acquired by the time information acquiring unit 230, position information acquired by the position information acquiring unit 240, and sensor information acquired by the sensor unit 250 to the risk of occurrence calculating apparatus 100. An image to which time information and position information have been linked may be uploaded to a predetermined receiving device via the communication unit 260.

The storage unit 270 stores a captured image captured by the imaging unit 220 with time information and position information linked to the captured image. A captured image stored in the storage unit 270 may be uploaded to the risk of occurrence calculating apparatus 100 via a storage.

Each component of the mobile imaging apparatus 200 described above may be served by a member constituting, for example, a driving recorder or a smartphone. In order to detect a road surface condition or a traveling condition, a desired component, such as a temperature measuring device or a sunshine measuring device, may be added, aside from the components described above. The installation position of each component is flexible, and each component may be installed inside or outside the mobile imaging apparatus 200 or the mobile body 210. For example, the storage unit 270 may be an external storage device or a storage device on the cloud.

### <Risk of Occurrence Calculating Apparatus>

The risk of occurrence calculating apparatus 100 is, for example, an information processing apparatus, such as a server apparatus or a personal computer. The risk of occurrence calculating apparatus 100 is not limited to being fixed to a predetermined spot and may be provided on the cloud.

As shown in FIG. 4, the risk of occurrence calculating apparatus 100 may include a storage unit 150, in addition to the image analyzing unit 110, the environmental information acquiring unit 120, the risk of occurrence calculating unit 130, and the display controlling unit 140 described above. The storage unit 150 has a function as a storage means.

The image analyzing unit 110 receives an image transmitted from a mobile imaging apparatus 200. The image analyzing unit 110 then analyzes the received image for information regarding at least any one of, for example, shadow on a road captured during imaging, the traffic volume (the volume of vehicles), or a crack. The image analyzing unit 110 may include a shadow detecting unit 111, a traffic volume detecting unit 112, and a crack detecting unit 113. The shadow detecting unit 111, the traffic volume detecting unit 112, and the crack detecting unit 113 have functions as, respectively, a shadow detecting means, a traffic volume detecting means, and a crack detecting means.

The shadow detecting unit 111 detects shadow in an image of a road. The traffic volume detecting unit 112 detects the traffic volume, such as the volume of vehicles, from an image of a road. The crack detecting unit 113 detects a crack in an image of a road. An analysis result resulting from an analysis by the image analyzing unit 110 is output to the risk of occurrence calculating apparatus 100.

The environmental information acquiring unit 120 acquires environmental information including at least any one of the weather, the temperature, the snow accumulation, the traffic volume, the presence of a rut, or a paving material (asphalt, concrete, drainage paving, etc.). The environmental information acquiring unit 120 acquires environmental information with the environmental information linked to time information and position information indicating the time at which and the position at which the environmental information has been detected. Environmental information to be acquired may be acquired from a mobile imaging apparatus 200 or from information that is available to the general public via the internet, or information that a user himself or herself holds may be acquired. For example, if a user is an administrator managing a road, the user holds information regarding a paving material. Therefore, environmental information that includes a paving material is acquired from the user. Environmental information that the environmental information acquiring unit 120 has acquired is output to the risk of occurrence calculating apparatus 100.

The risk of occurrence calculating unit 130 calculates a risk of occurrence based on an analysis result output from the image analyzing unit 110 and environmental information output from the environmental information acquiring unit 120. A risk of occurrence indicates the likelihood that an obstructing factor that may hinder passage on a road occurs. For example, a risk of occurrence indicates the likelihood that road surface freezing occurs. In another example, a risk of occurrence indicates the likelihood that a pothole occurs in a road. In this manner, a risk of occurrence is different from the status of any currently occurring freezing of a road surface or the status of any currently occurring pothole. A risk of occurrence may indicate the likelihood that an obstructing factor that obstructs passage on a road occurs.

The risk of occurrence calculating unit 130 may include a road surface freezing calculating unit 131 and a pothole calculating unit 132. The road surface freezing calculating unit 131 and the pothole calculating unit 132 have functions as, respectively, a calculating means that calculates a risk of occurrence of road surface freezing and a calculating means that calculates a risk of occurrence of a pothole.

The road surface freezing calculating unit 131 calculates a risk of occurrence indicating the likelihood that road surface freezing occurs in the future, based on an analysis result output from the image analyzing unit 110 and environmental information output from the environmental information acquiring unit 120. The pothole calculating unit 132 calculates a risk of occurrence indicating the likelihood that a pothole occurs in a road in the future, based on an analysis result output from the image analyzing unit 110 and environmental information output from the environmental information acquiring unit 120. A risk of occurrence that the risk of occurrence calculating unit 130 has calculated is linked to time information and position information and output to the display controlling unit 140 and the storage unit 150.

The display controlling unit 140 links a risk of occurrence output from the risk of occurrence calculating unit 130 or a risk of occurrence output from the storage unit 150 to map information indicating position information of a road. Specifically, the display controlling unit 140 performs control of displaying a risk of occurrence on map information in accordance with the level of the risk of occurrence. In this case, a risk of occurrence may be classified into one of a plurality of levels, and information may be presented in such a manner that the level can be readily recognized visually through a color or an icon that is clearly recognizable. For example, a spot and/or a segment where the risk of occurrence is extremely high may be displayed with a red arrow. A user may be able to set a threshold of a risk by which the risk is classified into a level. Furthermore, control may be performed so that a user can check, from map information, information serving as a basis for having the risk of occurrence calculated or an image of a specific spot providing evidence. Furthermore, time information may be linked to map information.

The storage unit 150 stores a risk of occurrence output from the risk of occurrence calculating unit 130 with time information and position information linked to the risk of occurrence. The storage unit 150 may be provided in a storage device external to the risk of occurrence calculating apparatus 100 or in a storage device on the cloud.

### <Display Apparatus>

The display apparatus 300 displays map information to which a risk of occurrence has been linked by the risk of occurrence calculating apparatus 100. For example, the display apparatus 300 receives map information controlled by the display controlling unit 140 from the risk of occurrence calculating apparatus 100 and displays the received map information to a user. The display apparatus 300 is, for example, a display-equipped terminal apparatus that a user has, such as a personal computer, a tablet, or a smartphone. The display apparatus 300, for example, may receive map information output from the risk of occurrence calculating apparatus 100 via the internet. The display apparatus 300 provides a user with a user interface having map information that the user can overlook to check the risk of occurrence of road surface freezing and of a pothole in the entire city.

### <Risk of Occurrence Displaying Method>

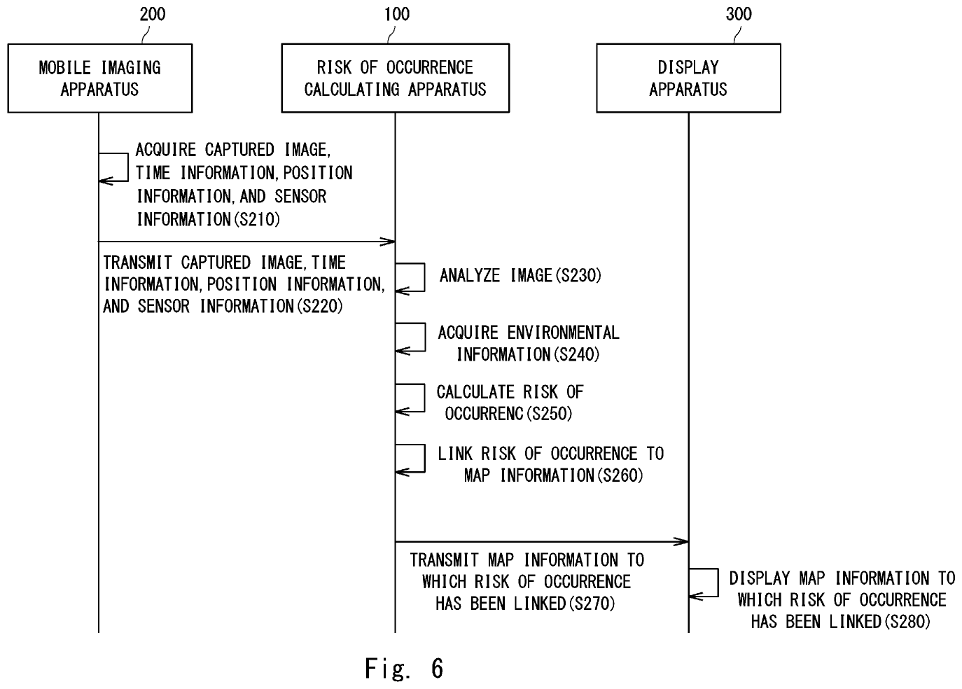

Next, a risk of occurrence displaying method performed by the risk of occurrence displaying system 11 will be described. FIG. 6 is a sequence diagram showing an example of a risk of occurrence displaying method according to the first example embodiment.

As indicated at step S210 in FIG. 6, the mobile imaging apparatus 200 captures an image of a road while moving and thus acquires a captured image. Furthermore, the mobile imaging apparatus 200 acquires time information, position information, and sensor information of the circumstance in which the image of the road is captured.

Next, as indicated at step S220, the mobile imaging apparatus 200 transmits the acquired captured image, time information, position information, and sensor information to the risk of occurrence calculating apparatus 100. In response, the risk of occurrence calculating apparatus 100 receives the captured image, the time information, the position information, and the sensor information.

Next, as indicated at step S230, the risk of occurrence calculating apparatus 100 analyzes the captured image output from the mobile imaging apparatus 200. For example, the risk of occurrence calculating apparatus 100 detects shadow, the traffic volume, and a crack from the image of the road.

As indicated at step S240, the risk of occurrence calculating apparatus 100 acquires environmental information. The risk of occurrence calculating apparatus 100 may acquire environmental information from the mobile imaging apparatus 200 or from information that is available to the general public via the internet or the like or may acquire information held by a user. It is to be noted that the order of steps S230 and S240 may be reversed, or steps S230 and S240 may be performed simultaneously.

As indicated at step S250, the risk of occurrence calculating apparatus 100 calculates a risk of occurrence based on the analysis result of the image of the road and the environmental information. For example, the risk of occurrence calculating apparatus 100 calculates a risk of occurrence of road surface freezing and a risk of occurrence of a pothole.

Next, as indicated at step S260, the risk of occurrence calculating apparatus 100 links the risk of occurrence to map information. The risk of occurrence calculating apparatus 100 may store the map information to which the risk of occurrence has been linked into the storage unit 150.

Next, as indicated at step S270, the risk of occurrence calculating apparatus 100 transmits the map information to which the risk of occurrence has been linked to the display apparatus 300. In response, the display apparatus 300 receives the map information to which the risk of occurrence has been linked.

Next, as indicated at step S280, the display apparatus 300 displays the map information to which the risk of occurrence has been linked.

### <Mobile Imaging Method>

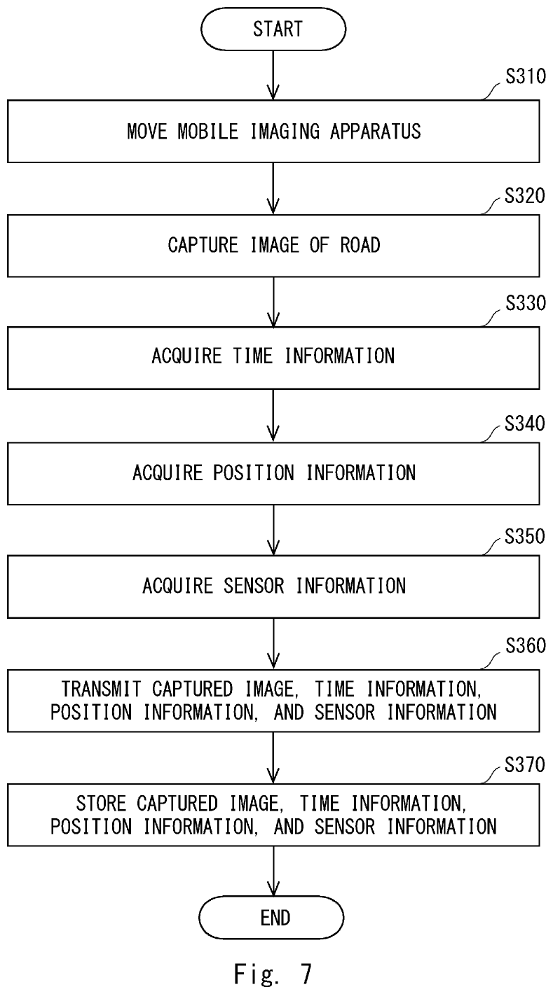

Next, a mobile imaging method performed by the mobile imaging apparatus 200 will be described. FIG. 7 is a flowchart showing an example of a mobile imaging method according to the first example embodiment.

As indicated at step S310 in FIG. 7, the mobile imaging apparatus 200 is moved. For example, the mobile imaging apparatus 200 is moved by moving the mobile body 210 provided with the mobile imaging apparatus 200.

Next, as indicated at step S320, an image of a road is captured. For example, the imaging unit 220 is caused to capture an image of a road.

Next, as indicated at step S330, time information is acquired. For example, the time information acquiring unit 230 is caused to acquire time information of the time at which the imaging unit 220 has captured the image of the road. Then, the time information acquiring unit 230 is caused to output the acquired time information to the imaging unit 220 to have the time information linked to the image.

As indicated at step S340, position information is acquired. For example, the position information acquiring unit 240 is caused to acquire position information of the position at which the imaging unit 220 has captured the image of the road. Then, the position information acquiring unit 240 is caused to output the acquired position information to the imaging unit 220 to have the position information linked to the image.

As indicated at step S350, sensor information is acquired. For example, the sensor unit 250 is caused to acquire sensor information. Then, the sensor unit 250 outputs the acquired sensor information to the imaging unit 220. It is to be noted that the order of steps S330 to S350 is not limited to the above. Steps S330 to S350 may be performed simultaneously.

Next, as indicated at step S360, the captured image, the time information, the position information, and the sensor information are transmitted to the risk of occurrence calculating apparatus 100. For example, the communication unit 260 transmits the captured image to which the time information and the position information have been linked to the risk of occurrence calculating apparatus 100.

Next, as indicated at step S370, the storage unit 270 may be caused to store the captured image, the time information, the position information, and the sensor information.

### <Risk of Occurrence Calculating Method>

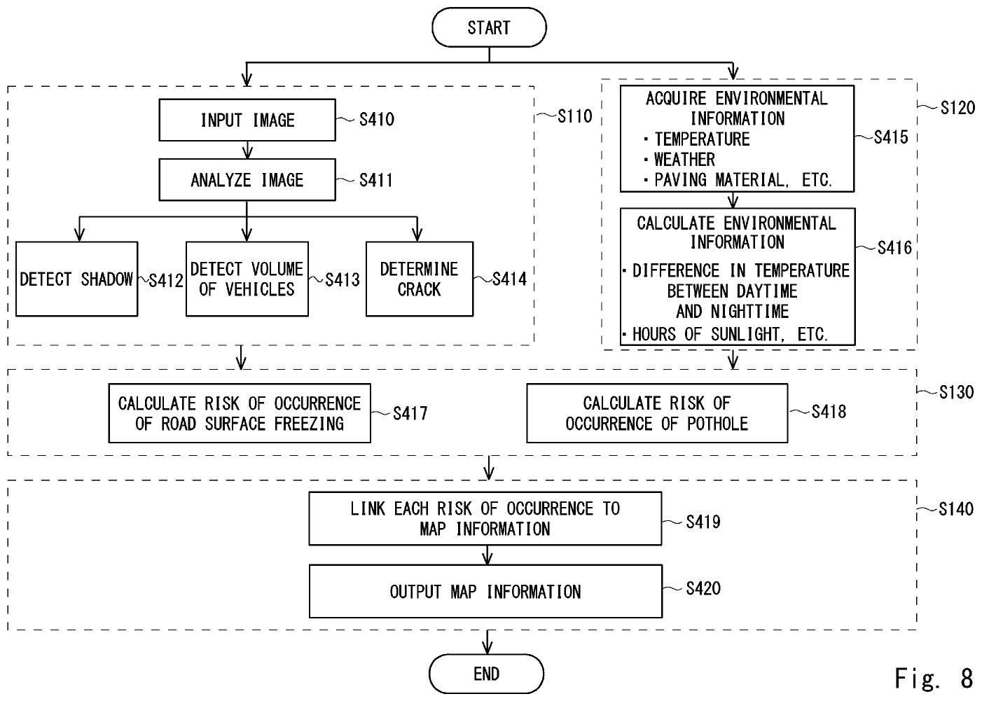

Next, a risk of occurrence calculating method performed by the risk of occurrence calculating apparatus 100 will be described. FIG. 8 is a flowchart showing an example of a risk of occurrence calculating method according to the first example embodiment. As shown in FIG. 8, similarly to the risk of occurrence calculating method according to an outline of an example embodiment described above, the risk of occurrence calculating method according to the present example embodiment includes steps S110 to S140.

At step S110 in FIG. 8, first, as indicated at step S410, an image of a road is input. Specifically, the image analyzing unit 110 receives input of an image of a road captured by a mobile imaging apparatus 200.

Next, as indicated at step S411, the image analyzing unit 110 analyzes the image. Specifically, as indicated at step S412, the shadow detecting unit 111 detects shadow in the image of the road. As indicated at step S413, the traffic volume detecting unit 112 detects the traffic volume, such as the volume of vehicles, from the image of the road. As indicated at step S414, the crack detecting unit 113 detects a crack in the image of the road. The analysis result resulting from the analysis by the image analyzing unit 110 is output to the risk of occurrence calculating unit 130.

At step S120, as indicated at step S415, the environmental information acquiring unit 120 acquires environmental information, such as temperature, weather, information regarding paving materials (asphalt, concrete, drainage paving, etc.), or snow accumulation, with such information linked to time information of the time at which and position information of the position at which the information has been detected. Next, as indicated at step S416, the environmental information acquiring unit 120 may perform a calculation with use of the environmental information to acquire environmental information, such as a difference in temperature between daytime and nighttime or the hours of sunlight. The environmental information that the environmental information acquiring unit 120 has acquired is output to the risk of occurrence calculating unit 130.

Next, at step S130, the risk of occurrence calculating unit 130 calculates a risk of occurrence. Herein, as examples of the risk of occurrence, a risk of occurrence of road surface freezing and a risk of occurrence of a pothole are used to describe a method of calculating a risk of occurrence.

As indicated at step S417, the road surface freezing calculating unit 131 calculates a risk of occurrence of road surface freezing indicating the likelihood that road surface freezing occurs in the future, based on the analysis result output from the image analyzing unit 110 and the environmental information output from the environmental information acquiring unit 120.

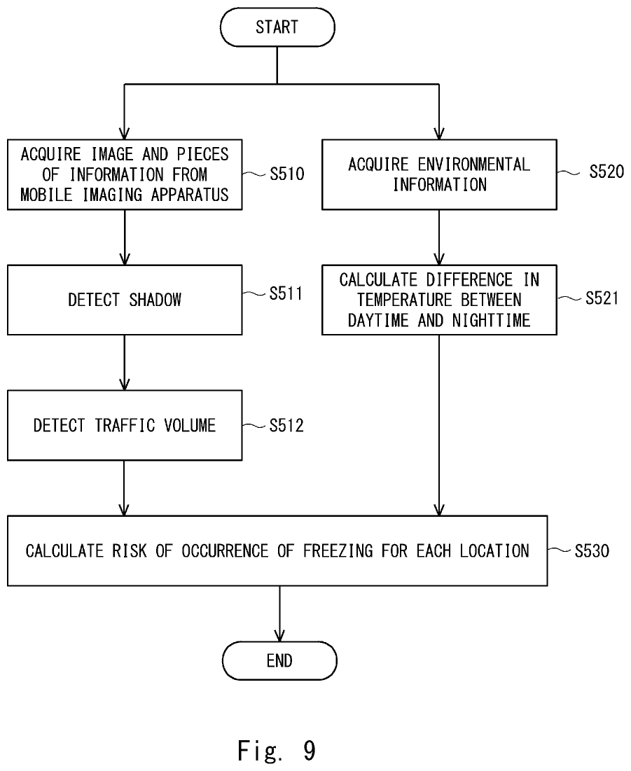

FIG. 9 is a flowchart showing an example of a method of calculating a risk of occurrence of road surface freezing according to the first example embodiment. As indicated at step S510 in FIG. 9, the image analyzing unit 110 acquires an image of a road along with information such as time information and position information from a mobile imaging apparatus 200.

Next, as indicated at step S511, the shadow detecting unit 111 detects shadow cast on the road surface from the image of the road. As indicated at step S512, the traffic volume detecting unit 112 detects the traffic volume, such as the volume of vehicles, based on the number of vehicles captured in the image of the road. It is to be noted that the order of steps S511 and S512 is not limited to the above, and the order may be reversed, or steps S511 and S512 may be performed simultaneously.

Meanwhile, as indicated at step S520, the environmental information acquiring unit 120 acquires environmental information, such as temperature. For example, based on the time information, the position information, and so forth output along with the captured image from the mobile imaging apparatus 200, the environmental information acquiring unit 120 may acquire environmental information, such as weather, temperature, information regarding paving materials (asphalt, concrete, drainage paving, etc.), or snow accumulation, observed when the image has been captured. Next, as indicated at step S521, the environmental information acquiring unit 120 performs a calculation with use of the environmental information, such as temperature, to acquire a difference in temperature between daytime and nighttime.

Next, as indicated at step S530, by integrally taking into account the analysis result output from the image analyzing unit 110 and the environmental information output from the environmental information acquiring unit 120, the road surface freezing calculating unit 131 calculates, for each location, a risk of occurrence of road surface freezing indicating the likelihood that road surface freezing occurs.

A specific example of a method of calculating a risk of occurrence of road surface freezing will be described below. For example, a risk of occurrence of road surface freezing K1 [%] is calculated though Equation (1).

K1=((α1+α2+α3)/3)×100 (1)

In the above, α1 represents the degree of influence of shadow, α2 represents the degree of influence of a difference in temperature between daytime and nighttime, and α3 represents the degree of influence of the traffic volume.

The degree of influence α1 of shadow may be defined, for example, as follows: α1=0.0 if shadow covers less than 30 [%] of the area of the road surface region, α1=0.6 if shadow covers no less than 30 [%] but less than 70 [%] of the area of the road surface region, and α1=1.0 if shadow covers no less than 70 [%] of the area of the road surface region.

The degree of influence α2 of a difference in temperature between daytime and nighttime may be defined as follows: α2=0.2 if the difference in temperature between daytime and nighttime is less than 5 [° C.], α2=0.5 if the difference in temperature between daytime and nighttime is no less than 5 [° C.] but less than 10 [° C.], and α2=1.0 if the difference in temperature between daytime and nighttime is no less than 10 [° C.].

The degree of influence α3 of the traffic volume may be defined as follows: α3=0.0 if the traffic volume on the road is less than 1,000 vehicles a day per direction and α3=0.8 if the traffic volume on the road is no less than 1,000 vehicles a day per direction.

The risk of occurrence of road surface freezing K1 [%] may be calculated in this manner. It is to be noted that this method of calculating a risk of occurrence of road surface freezing is an example, and the items used in the method of calculating the degree of influence or in the method of calculating a risk of occurrence of road surface freezing as well as the thresholds and the degrees of influence for each item may be changed. For example, the degree of influence α1 of shadow may be defined as, for example, (area of shadow region)×(the degree of importance (weight) of shadow in road surface freezing). Parameters α4 and α5 representing the presence of a bridge and of a mountain pass where a road surface is likely to become frozen may be added, or an item or items that are considered important may be given a weight. Furthermore, for example, a machine learning model may be constructed to create a model dedicated to calculating a risk of occurrence.

A risk of occurrence may be set to be increased as there are more conditions such as the following. Specifically, a frozen road covered with a large amount of shadow on a sunny day naturally melts less easily, and thus the risk of occurrence is increased. Even if sunlight shines on a road during daytime, if the temperature drops in the evening and the difference in temperature between daytime and nighttime becomes large, the road becomes covered by a crust of ice, and thus the risk of occurrence is increased. Snow on a road is more likely to be pressed to turn into ice as the traffic volume is higher, and such a road should preferentially be cleared of snow, and thus the risk of occurrence is increased.

Referring back to FIG. 8, as indicated at step S418, the pothole calculating unit 132 calculates a risk of occurrence of a pothole indicating the likelihood that a pothole occurs in the road in the future, based on the analysis result output from the image analyzing unit 110 and the environmental information output from the environmental information acquiring unit 120.

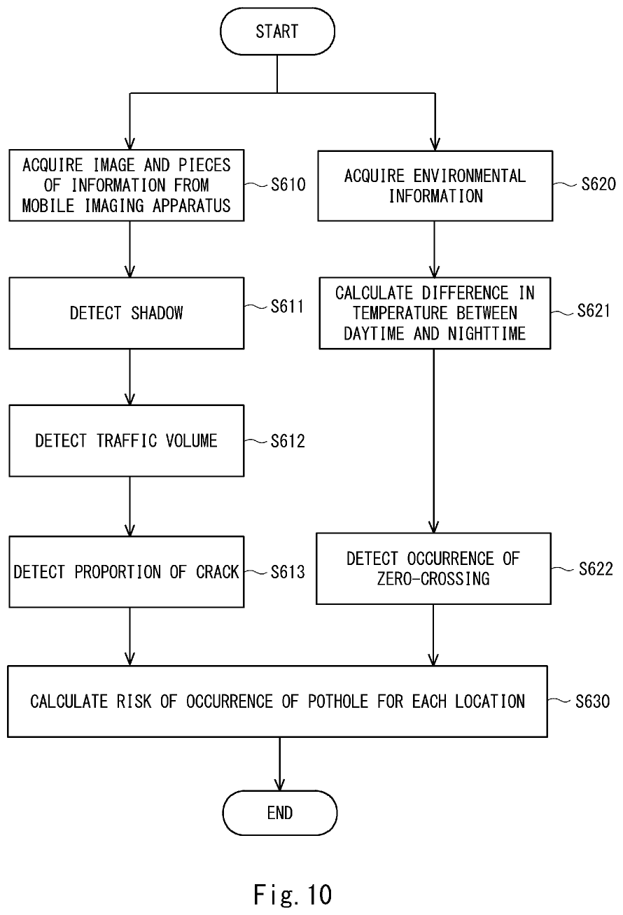

FIG. 10 is a flowchart showing an example of a method of calculating a risk of occurrence of a pothole according to the first example embodiment. Steps S610 to S612, S620, and S621 in FIG. 10 are similar to steps S510 to S512, S520, and S521 in FIG. 9.

As indicated at step S613 in FIG. 10, the crack detecting unit 113 detects the proportion of a crack from the image of the road. As indicated at step S622, the environmental information acquiring unit 120 detects a zero-crossing, that is, an occurrence of a state in which the temperature falls below 0 [° C.].

Next, as indicated at step S630, by integrally taking into account the analysis result output from the image analyzing unit 110 and the environmental information output from the environmental information acquiring unit 120, the pothole calculating unit 132 calculates, for each location, a risk of occurrence of a pothole indicating the likelihood that a pothole occurs.

A specific example of the method of calculating a risk of occurrence of a pothole will be described below. For example, a risk of occurrence of a pothole K2 [%] is calculated though Equation (1).

K2=((β1+β2+β3+β4)/4)×100 (2)

In the above, β1 represents the degree of influence of the season, β2 represents the degree of influence of the proportion of a crack, β3 represents the degree of influence of the traffic volume, and β4 represents the degree of influence of a zero-crossing.

The degree of influence β1 of the season may be defined, for example, as follows: β1=1.0 if it is a snow-melting season and β1=0.0 if it is not a snow-melting season.

The degree of influence β2 of the proportion of a crack may be defined as follows: β2=0.2 if the proportion of a crack is less than 20 [%], 2=0.5 if the proportion of a crack is no less than 20 [%] but less than 40 [%], and 32=1.0 if the proportion of a crack is no less than 40 [%].

The degree of influence β3 of the traffic volume may be defined as follows: α3=0.0 if the traffic volume on the road is less than 1,000 vehicles a day per direction and β3=0.8 if the traffic volume on the road is no less than 1,000 vehicles a day per direction.

The degree of influence β4 of a zero-crossing may be defined as follows: β4=1.0 if there is, within the last one to two days, a day on which the temperature has fallen below 0 [° C.] and β4=0.0 if the condition above does not apply.

The risk of occurrence of a pothole K2 [%] may be calculated in this manner. It is to be noted that the method of calculating a risk of occurrence of a pothole is an example, and the items used in the method of calculating the degree of influence or in the method of calculating a risk of occurrence of a pothole as well as the thresholds and the degrees of influence for each item may be changed, or an item or items that are considered important may be given a weight. Furthermore, for example, a machine learning model may be constructed to create a model dedicated to calculating a risk of occurrence.

A risk may be set to be increased as there are more conditions such as the following. Specifically, the risk of occurrence is increased during a season in which more potholes tend to occur, that is, during a snow-melting season. The risk of occurrence is increased for a spot where a pothole is likely to occur, such as a weakened spot with, for example, a crack or a seam. The risk of occurrence is increased for a spot where meltwater is likely to flow into or pool. A section or a pass with a high proportion of cracks or in particular with a hexagonal crack is highly likely to turn into a pothole, and thus the risk of occurrence of such a spot is increased. Regarding the weather condition observed in connection with an occurrence of a pothole, a pothole tends to occur on the day on which a zero-crossing is observed or one to two days afterwards, and thus the risk of occurrence is increased in such a case.

Next, at step S140 in FIG. 8, as indicated at step S419, the display controlling unit 140 links the risk of occurrence of road surface freezing and the risk of occurrence of a pothole to map information indicating the position information of the road. Next, as indicated at step S420, the display controlling unit 140 outputs the map information to which the risk of occurrence of road surface freezing and the risk of occurrence of a pothole have been linked to the display apparatus 300.

Next, some advantageous effects of the present example embodiment will be described. According to the present example embodiment, data including image information of a road surface gathered while a mobile imaging apparatus 200 is traveling is collected from the mobile imaging apparatus 200, and the data is analyzed. Thus, a risk of occurrence of road surface freezing or of a pothole can be calculated. Then, such information can be displayed on a user interface in the form of map information. In this manner, it is not that simply the status of occurring road surface freezing or pothole is presented, but with the conditions in which road surface freezing or a pothole is likely to occur are integrally taken into account, a risk of occurrence indicating the likelihood that road surface freezing or a pothole occurs in the future can be estimated and presented in advance. This makes it possible to improve a service pertaining to road management.

Unlike a related freezing information presentation system, an apparatus that acquires information is mobile, and thus a risk of occurrence of road surface freezing or of a pothole can be calculated for more finely divided segments aside from a fixed location. Therefore, information overlooking the entire city can be provided. Furthermore, a risk of occurrence of a pothole, an occurrence of which is unpredictable and is very hard to manage, can be presented. This makes it possible to provide the order of priority of locations where a road managing personnel should patrol.

The risk of occurrence displaying system 11 according to the present example embodiment can collect data on a road with use of an inexpensive, general-purpose camera (driving recorder, smartphone, etc.) without using an expensive, dedicated device, sensor, or the like, and thus the cost can be reduced.

The use of not a fixed camera but a movable camera attached to a mobile body 210 (a patrolling vehicle of a local government, a delivery vehicle, a garbage truck, etc.) makes it possible to grasp a detailed road surface condition of each road including small neighborhood streets. Furthermore, a road surface condition can be grasped frequently. Therefore, roads can be managed and monitored per road or per time more finely divided than before.

Presenting not only the current status of any occurrence but also a risk of occurrence on a map makes it possible to visualize the overall condition of the entire city, and such presentation can be used to prioritize a route that should be patrolled preferentially.

The risk of occurrence displaying system 11 according to the present example embodiment may accumulate daily analysis results, acquired information, and results of calculating a risk of occurrence in the storage unit 150. Then, the risk of occurrence displaying system 11 may statistically process the results of multiple days at the same location in the time direction. For example, if the distribution of risks of occurrence calculated in one week for a certain location indicates that the risk of occurrence on only one day is clearly higher or lower than the risks of occurrence on the other days, there is a possibility of an erroneous determination. Therefore, determining as an erroneous determination from the statistical standpoint, a method may be adopted in which a mean risk of occurrence, for example, is presented to remove noise and estimate and display a more accurate risk of occurrence. Other than a mean value, an algorithm that defines a desired (e.g., with a modal value) statistical value may be set. In this case, data in a database accumulated in the risk of occurrence calculating apparatus 100 may be recalculated statistically, and information may be provided to the display controlling unit 140.

### Second Example Embodiment

Next, a risk of occurrence displaying system according to a second example embodiment will be described. The risk of occurrence displaying system according to the present example embodiment may calculate, as a risk of occurrence, the likelihood of an occurrence of freezing on a line for a road surface sign provided on a road. A line for a road surface sign includes, for example, a crosswalk, a center line, a passing line, and a speed limit indicator provided on a road surface. Therefore, in addition to the items concerning the calculation of a risk of occurrence described above according to the first example embodiment, the following environmental information may be additionally taken into account as, for example, γ1 to γ4, and an analysis and a calculation may be performed by the risk of occurrence calculating apparatus 100. A risk of occurrence is not limited to that which γ1 to γ4 are added to the items α1 to α3 and/or β1 to β4 concerning the calculation of a risk of occurrence described according to the first example embodiment. A calculated risk of occurrence is displayed on a user interface with the risk of occurrence linked to map information.
most recent rain
zero-crossing
increase or decrease in traffic volume
material of line for road surface sign (for newer ones, drainage performance may be taken into consideration) and the shape (including the area)

For example, if a user is an administrator managing a road, the user knows materials and shapes of lines for road surface signs. Thus, environmental information that includes a material and a shape of a line for a road surface sign is acquired from the user.

The risk of occurrence displaying system may calculate, as a risk of occurrence, the likelihood that a pile of snow that has accumulated on a shoulder or a pedestrian walkway of a road occurs. A pile of snow that accumulates on a shoulder or a pedestrian walkway of a road is formed as snow that has fallen on a road surface is gathered to the shoulder or the pedestrian walkway. Therefore, in addition to the items concerning the calculation of a risk of occurrence described above according to the first example embodiment, the following elements may be additionally taken into account as, for example, δ1 to δ4, and an analysis and a calculation may be performed by the risk of occurrence calculating apparatus 100. A risk of occurrence is not limited to that which δ1 to δ4 are added to the items α1 to β3 and/or β1 to β4 concerning the calculation of a risk of occurrence described according to the first example embodiment. A calculated risk of occurrence is displayed on a user interface with the risk of occurrence linked to map information.
Whether there is any pile of snow formed by snow pushed or shoved to a shoulder or a pedestrian walkway (such a pile of snow obstructs one's view, creating a danger in which one cannot see an object running out into the road).
height parameter of a pile of snow
lane width parameter (a pile of snow tends to reduce the region on which a vehicle can travel).
schedule of snow removal

For example, if a user is an administrator managing a road, the user has the schedule of snow removal. Thus, environmental information including the schedule of snow removal is acquired from the user.

According to the present example embodiment, the likelihood of an occurrence of a high-risk obstructing factor that might be overlooked, such as freezing on a line for a road surface sign or a pile of snow, can be calculated. Furthermore, since environmental information that only an administrator of a road can get a hold of is used, a risk of occurrence can be calculated with high accuracy.

Thus far, the invention of the present application has been described with reference to the first and second example embodiments, but the first and second example embodiments do not limit the invention of the present application. Various modifications that a person skilled in the art can appreciate can be made to the configurations and the details of the invention of the present application within the scope of the invention of the present application. For example, an example embodiment obtained by combining the components of the first and second example embodiments is also encompassed by the technical scope and spirit.

Part or the whole of the foregoing example embodiments can be expressed also as in the following supplementary notes, which are not limiting.

(Supplementary Note 1)

A risk of occurrence calculating apparatus comprising:
image analyzing means configured to analyze an image of a road;
environmental information acquiring means configured to acquire environmental information of surroundings of the road;
risk of occurrence calculating means configured to calculate a risk of occurrence indicating a likelihood that an obstructing factor that may hinder passage on the road occurs, based on an analysis result resulting from an analysis by the image analyzing means and the environmental information acquired by the environmental information acquiring means; and
display controlling means configured to link the risk of occurrence to map information indicating position information of the road.

(Supplementary Note 2)

The risk of occurrence calculating apparatus according to Supplementary Note 1, wherein the risk of occurrence indicates a likelihood that road surface freezing of the road occurs.

(Supplementary Note 3)

The risk of occurrence calculating apparatus according to Supplementary Note 1, wherein the risk of occurrence indicates a likelihood that freezing on a line for a road surface sign provided on the road occurs.

(Supplementary Note 4)

The risk of occurrence calculating apparatus according to Supplementary Note 1, wherein the risk of occurrence indicates a likelihood that a pile of snow accumulated on a shoulder or a pedestrian walkway of the road occurs.

(Supplementary Note 5)

The risk of occurrence calculating apparatus according to Supplementary Note 1, wherein the risk of occurrence indicates a likelihood that a pothole occurs in the road.

(Supplementary Note 6)

The risk of occurrence calculating apparatus according to any one of Supplementary Notes 1 to 5, wherein the image analyzing means is configured to analyze at least any one of shadow, a traffic volume, or a crack from the image.

(Supplementary Note 7)

The risk of occurrence calculating apparatus according to any one of Supplementary Notes 1 to 6, wherein the environmental information includes at least any one of weather, temperature, snow accumulation, a traffic volume, presence of a rut, or a paving material.

(Supplementary Note 8)

A risk of occurrence displaying system comprising:
a mobile imaging apparatus configured to capture an image of a road while moving and acquire position information of the road;
a risk of occurrence calculating apparatus configured to calculate a risk of occurrence indicating a likelihood that an obstructing factor that may hinder passage on the road occurs, based on an analysis result resulting from an analysis of the image output from the mobile imaging apparatus and environmental information of surroundings of the road, and link the calculated risk of occurrence to map information indicating the position information of the road; and
a display apparatus configured to display the map information to which the risk of occurrence has been linked by the risk of occurrence calculating apparatus.

(Supplementary Note 9)

The risk of occurrence displaying system according to Supplementary Note 8, wherein the risk of occurrence indicates a likelihood that road surface freezing of the road occurs.

(Supplementary Note 10)

The risk of occurrence displaying system according to Supplementary Note 8, wherein the risk of occurrence indicates a likelihood that freezing on a line for a road surface sign provided on the road occurs.

(Supplementary Note 11)

The risk of occurrence displaying system according to Supplementary Note 8, wherein the risk of occurrence indicates a likelihood that a pile of snow accumulated on a shoulder or a pedestrian walkway of the road occurs.

(Supplementary Note 12)

The risk of occurrence displaying system according to Supplementary Note 8, wherein the risk of occurrence indicates a likelihood that a pothole occurs in the road.

(Supplementary Note 13)

The risk of occurrence displaying system according to any one of Supplementary Notes 8 to 12, wherein the risk of occurrence calculating apparatus is configured to analyze image information regarding at least any one of shadow, a traffic volume, or a crack from the image.

(Supplementary Note 14)

The risk of occurrence displaying system according to any one of Supplementary Notes 8 to 13, wherein the environmental information includes at least any one of weather, temperature, snow accumulation, a traffic volume, presence of a rut, or a paving material.

(Supplementary Note 15)

A risk of occurrence calculating method comprising:
analyzing an image of a road;
acquiring environmental information of surroundings of the road;
calculating a risk of occurrence indicating a likelihood that an obstructing factor that may hinder passage on the road occurs, based on an analysis result resulting from an analysis of the image and the acquired environmental information; and
linking the risk of occurrence to map information indicating position information of the road.

(Supplementary Note 16)

The risk of occurrence calculating method according to Supplementary Note 15, wherein the risk of occurrence indicates a likelihood that road surface freezing of the road occurs.

(Supplementary Note 17)

The risk of occurrence calculating method according to Supplementary Note 15, wherein the risk of occurrence indicates a likelihood that freezing on a line for a road surface sign provided on the road occurs.

(Supplementary Note 18)

The risk of occurrence calculating method according to Supplementary Note 15, wherein the risk of occurrence indicates a likelihood that a pile of snow accumulated on a shoulder or a pedestrian walkway of the road occurs.

(Supplementary Note 19)

The risk of occurrence calculating method according to Supplementary Note 15, wherein the risk of occurrence indicates a likelihood that a pothole occurs in the road.

(Supplementary Note 20)

The risk of occurrence calculating method according to any one of Supplementary Notes 15 to 19, wherein when analyzing the image of the road, at least any one of shadow, a traffic volume, or a crack is analyzed from the image.

(Supplementary Note 21)

The risk of occurrence calculating method according to any one of Supplementary Notes 15 to 20, wherein the environmental information includes at least any one of weather, temperature, snow accumulation, a traffic volume, presence of a rut, or a paving material.

(Supplementary Note 22)

A non-transitory computer-readable medium storing a risk of occurrence calculating program that causes a computer to execute:
analyzing an image of a road;
acquiring environmental information of surroundings of the road;
calculating a risk of occurrence indicating a likelihood that an obstructing factor that may hinder passage on the road occurs, based on an analysis result resulting from an analysis of the image and the acquired environmental information; and
linking the risk of occurrence to map information indicating position information of the road.

(Supplementary Note 23)

The non-transitory computer-readable medium storing a risk of occurrence calculating program according to Supplementary Note 22, wherein the risk of occurrence indicates a likelihood that road surface freezing of the road occurs.

(Supplementary Note 24)

The non-transitory computer-readable medium storing a risk of occurrence calculating program according to Supplementary Note 22, wherein the risk of occurrence indicates a likelihood that freezing on a line for a road surface sign provided on the road occurs.

(Supplementary Note 25)

The non-transitory computer-readable medium storing a risk of occurrence calculating program according to Supplementary Note 22, wherein the risk of occurrence indicates a likelihood that a pile of snow accumulated on a shoulder or a pedestrian walkway of the road occurs.

(Supplementary Note 26)

The non-transitory computer-readable medium storing a risk of occurrence calculating program according to Supplementary Note 22, wherein the risk of occurrence indicates a likelihood that a pothole occurs in the road.

(Supplementary Note 27)

The non-transitory computer-readable medium storing a risk of occurrence calculating program according to any one of Supplementary Notes 22 to 26, wherein when analyzing the image of the road, a computer is caused to analyze at least any one of shadow, a traffic volume, or a crack from the image.

(Supplementary Note 28)

The non-transitory computer-readable medium storing a risk of occurrence calculating program according to any one of Supplementary Notes 22 to 27, wherein the environmental information includes at least any one of weather, temperature, snow accumulation, a traffic volume, presence of a rut, or a paving material.

In the above-described example, the program can be stored using various types of non-transitory computer readable media to be supplied to a computer. The non-transitory computer readable media include various types of tangible storage media. Examples of the non-transitory computer readable medium include a magnetic recording medium (for example, a flexible disk, a magnetic tape, or a hard disk drive), an optical magnetic recording medium (for example, a magneto-optical disk), a compact disc-read only memory (CD-ROM), a CD-R, a CD-R/W, and a semiconductor memory such as a mask ROM, a programmable ROM (PROM), an erasable PROM (EPROM), a flash ROM, or a random access memory (RAM). In addition, the program may be supplied to the computer by various types of transitory computer readable media. Examples of the transitory computer readable media include electric signals, optical signals, and electromagnetic waves. The transitory computer readable medium can provide the program to the computer via a wired communication line such as an electric wire and optical fibers or a wireless communication line.

### REFERENCE SIGNS LIST

10, 11 RISK OF OCCURRENCE DISPLAYING SYSTEM
100 RISK OF OCCURRENCE CALCULATING APPARATUS
110 IMAGE ANALYZING UNIT
111 SHADOW DETECTING UNIT
112 TRAFFIC VOLUME DETECTING UNIT
113 CRACK DETECTING UNIT
120 ENVIRONMENTAL INFORMATION ACQUIRING UNIT
130 RISK OF OCCURRENCE CALCULATING UNIT
131 ROAD SURFACE FREEZING CALCULATING UNIT
132 POTHOLE CALCULATING UNIT
140 DISPLAY CONTROLLING UNIT
150 STORAGE UNIT
200 MOBILE IMAGING APPARATUS
210 MOBILE BODY
220 IMAGING UNIT
230 TIME INFORMATION ACQUIRING UNIT
240 POSITION INFORMATION ACQUIRING UNIT
250 SENSOR UNIT
260 COMMUNICATION UNIT
270 STORAGE UNIT
300 DISPLAY APPARATUS

What is claimed is:

1. A risk of occurrence calculating apparatus comprising:
image analyzing unit configured to analyze an image of a road;
environmental information acquiring unit configured to acquire environmental information of surroundings of the road;
risk of occurrence calculating unit configured to calculate a risk of occurrence indicating a likelihood that an obstructing factor that may hinder passage on the road occurs, based on an analysis result resulting from an analysis by the image analyzing unit and the environmental information acquired by the environmental information acquiring unit; and
display controlling unit configured to link the risk of occurrence to map information indicating position information of the road.

2. The risk of occurrence calculating apparatus according to claim 1, wherein the risk of occurrence indicates a likelihood that road surface freezing of the road occurs.

3. The risk of occurrence calculating apparatus according to claim 1, wherein the risk of occurrence indicates a likelihood that freezing on a line for a road surface sign provided on the road occurs.

4. The risk of occurrence calculating apparatus according to claim 1, wherein the risk of occurrence indicates a likelihood that a pile of snow accumulated on a shoulder or a pedestrian walkway of the road occurs.

5. The risk of occurrence calculating apparatus according to claim 1, wherein the risk of occurrence indicates a likelihood that a pothole occurs in the road.

6. The risk of occurrence calculating apparatus according to claim 1, wherein the image analyzing unit is configured to analyze at least any one of shadow, a traffic volume, or a crack from the image.

7. The risk of occurrence calculating apparatus according to claim 1, wherein the environmental information includes at least any one of weather, temperature, snow accumulation, a traffic volume, presence of a rut, or a paving material.

8. A risk of occurrence displaying system comprising:
a mobile imaging apparatus configured to capture an image of a road while moving and acquire position information of the road,
a risk of occurrence calculating apparatus configured to calculate a risk of occurrence indicating a likelihood that an obstructing factor that may hinder passage on the road occurs, based on an analysis result resulting from an analysis of the image output from the mobile imaging apparatus and environmental information of surroundings of the road, and link the calculated risk of occurrence to map information indicating the position information of the road; and
a display apparatus configured to display the map information to which the risk of occurrence has been linked by the risk of occurrence calculating apparatus.

9. The risk of occurrence displaying system according to claim 8, wherein the risk of occurrence indicates a likelihood that road surface freezing of the road occurs.

10. The risk of occurrence displaying system according to claim 8, wherein the risk of occurrence indicates a likelihood that freezing on a line for a road surface sign provided on the road occurs.

11. The risk of occurrence displaying system according to claim 8, wherein the risk of occurrence indicates a likelihood that a pile of snow accumulated on a shoulder or a pedestrian walkway of the road occurs.

12. The risk of occurrence displaying system according to claim 8, wherein the risk of occurrence indicates a likelihood that a pothole occurs in the road.

13. The risk of occurrence displaying system according to claim 8, wherein the risk of occurrence calculating apparatus is configured to analyze image information regarding at least any one of shadow, a traffic volume, or a crack from the image.

14. The risk of occurrence displaying system according to claim 8, wherein the environmental information includes at least any one of weather, temperature, snow accumulation, a traffic volume, presence of a rut, or a paving material.

15. A risk of occurrence calculating method comprising:
analyzing an image of a road;
acquiring environmental information of surroundings of the road;
calculating a risk of occurrence indicating a likelihood that an obstructing factor that may hinder passage on the road occurs, based on an analysis result resulting from an analysis of the image and the acquired environmental information; and
linking the risk of occurrence to map information indicating position information of the road.

16. The risk of occurrence calculating method according to claim 15, wherein the risk of occurrence indicates a likelihood that road surface freezing of the road occurs.

17. The risk of occurrence calculating method according to claim 15, wherein the risk of occurrence indicates a likelihood that freezing on a line for a road surface sign provided on the road occurs.

18. The risk of occurrence calculating method according to claim 15, wherein the risk of occurrence indicates a likelihood that a pile of snow accumulated on a shoulder or a pedestrian walkway of the road occurs.

19. The risk of occurrence calculating method according to claim 15, wherein the risk of occurrence indicates a likelihood that a pothole occurs in the road.

20. The risk of occurrence calculating method according to claim 15, wherein when analyzing the image of the road, at least any one of shadow, a traffic volume, or a crack is analyzed from the image.

21-28. (canceled)
